(19) United States
(12) Patent Application Publication
(10) Pub. No.: US 2020/0073858 A1
(43) Pub. Date: Mar. 5, 2020

(54) IMAGE PROCESSING APPARATUS, IMAGE PROCESSING METHOD, AND PROGRAM

(71) Applicant: CANON KABUSHIKI KAISHA, Tokyo (JP)

(72) Inventors: Koji Maeda, Kawasaki-shi (JP); Shigeyuki Mitani, Yokohama-shi (JP); Hiroyuki Owatari, Saitama-shi (JP); Yumiko Kuno, Tokyo (JP)

(21) Appl. No.: 16/549,747

(22) Filed: Aug. 23, 2019

(30) Foreign Application Priority Data
Aug. 31, 2018 (JP) 2018-162745

(51) Int. Cl. G06F 16/18; G06F 3/0484; G06T 11/00; G06T 11/60

(52) U.S. Cl. CPC G06F 16/1873; G06F 3/04845; G06T 2207/20092; G06T 11/60; G06T 11/001

(57) ABSTRACT

A system is provided whereby a user can easily distinguish, in an editing history, an edit content being applied to an image and an edit content not being applied to the image. An image processing apparatus includes an editing unit configured to edit an image according to user's operation, a storage unit configured to store, in a storage medium, an editing history indicating an edit content executed by the editing unit by associating the editing history with the image. A display processing unit is configured to display each edit content on a screen in a different manner depending on being applied to the image or not being applied to the image.

### BACKGROUND

### Field

The present disclosure relates to an image processing apparatus, an image processing method, and a program.

### Description of the Related Art

Conventionally, there is known a method of displaying a history of image editing with a character string or an icon, and arranging and displaying all the histories in time series. This method shows a type of an editing item related to histories using a character string or an icon so that the user can distinguish each history. Further, Japanese Patent Laid-Open No. 2001-34775 discloses a technique of displaying an image of an image processing result in a main area and displaying images before the image processing in time series in a subarea.

When the image to be edited is a RAW image, the latest edit content of the edit contents in a same editing item is being applied to the image. However, in the conventional art, since the edit contents are displayed by mixing a plurality of editing items in chronological order, there has been a problem that the edit content being applied and the edit content not being applied in each editing item cannot be distinguished based on the display of the editing history.

### SUMMARY OF THE INVENTION

The present disclosure has been made in view of certain drawbacks, and provides a system by which the user can easily recognize, in an editing history, an edit content being applied to an image and an edit content not being applied to the image in each editing item in the editing history.

The present disclosure is an image processing apparatus including an editing unit configured to edit an image according to user's operation and a storage unit configured to store, in a storage medium, an editing history indicating an edit content executed by the editing unit by associating the editing history with the image. A display processing unit is configured to display each edit content on a screen in a different manner depending on being applied to the image or not being applied to the image.

Further features of the present disclosure will become apparent from the following description of exemplary embodiments (with reference to the attached drawings).

### BRIEF DESCRIPTION OF THE DRAWINGS

FIG. 1 is a hardware configuration diagram of an image processing apparatus.

FIG. 2 is a diagram illustrating a functional configuration of the image processing apparatus.

FIG. 3 is a functional configuration diagram of a development processing unit.

FIG. 4 is a diagram illustrating an example of an image editing screen.

FIG. 5 is a flowchart illustrating an image editing process.

FIGS. 6A to 6C are explanatory diagrams of a process of displaying an editing history.

FIGS. 7A and 7B are diagrams illustrating a display example of an editing history area.

FIG. 8 is a flowchart illustrating an image editing process.

### DESCRIPTION OF THE EMBODIMENTS

In the following, exemplary embodiments will be described with reference to the drawings.

### First Exemplary Embodiment

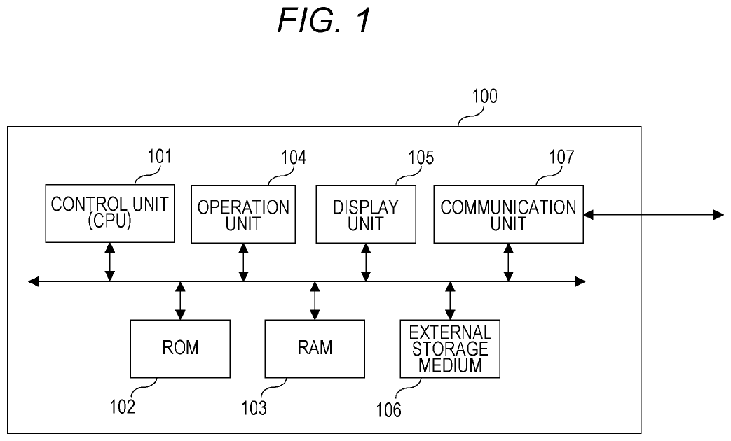

FIG. 1 is a hardware configuration diagram of an image processing apparatus 100 according to the present exemplary embodiment. In the image processing apparatus 100, the reference numeral 101 denotes a central processing unit (CPU) that controls overall control of the image processing apparatus and operation of an image editing process or a history management process. The reference numeral 102 denotes a ROM, which is a hard disk drive, an SSD, or the like in which digital data such as an execution program for the image editing process and an encoded image signal are recorded in a readable format. The reference numeral 103 denotes a RAM, in which program codes and digital data recorded in the ROM 102 are loaded and the program code or digital data are executed by the control unit 101. The reference numeral 104 is an operation input unit composed of a keyboard, a mouse, or a touch operation. The control unit 101 detects an input from the operation unit 104, the input is given in notification to the program loaded in the RAM 103, and the process is executed. The reference numeral 105 denotes a display unit such as a CRT display, a liquid crystal panel, or the like, which displays various information. The reference numeral 106 denotes an external recording medium that can save a RAW image and an image editing result generated by applying an editing process to the RAW image. The reference numeral 107 denotes a communication unit, which is an interface to connect to a network such as the Internet or an interface to communicate with an external device and can receive an image as an editing target.

Here, later described functions or operation of the image processing apparatus 100 are realized by the control unit 101 reading the program stored in the ROM 102 or the external storage medium 106 and executing the program.

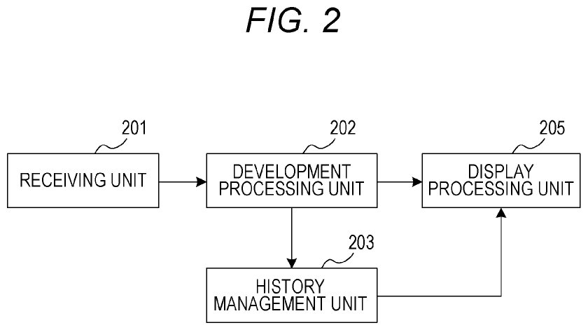

FIG. 2 is a diagram illustrating a functional configuration of the image processing apparatus 100. The image processing apparatus 100 includes a receiving unit 201, a development processing unit 202, a history management unit 203, and a display processing unit 205. The receiving unit 201 receives various instructions corresponding to user's operation. The development processing unit 202 develops an image as a processing target. According to the present exemplary embodiment, the image as the processing target is a RAW image. The history management unit 203 manages history information related to a series of editing of the RAW image, and stores the history information in the external storage medium 106. The display processing unit 205 performs processing to display various information on the display unit 105.

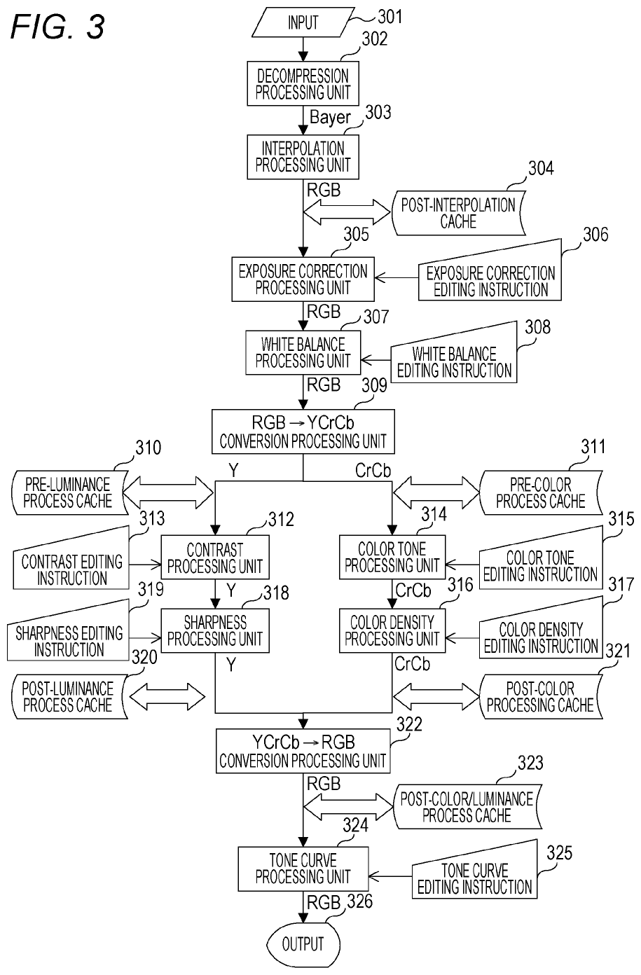

FIG. 3 is a functional configuration diagram of the development processing unit 202. The development processing unit 202 performs an editing process on the RAW image. The order of the editing process is determined in advance. When the development processing unit 202 acquires an editing instruction via the receiving unit 201, the development processing unit 202 updates an adjustment value according to the editing instruction, and edits the image as the processing target with the updated adjustment value. When the development processing unit 202 does not acquire the editing instruction, the development processing unit 202 edits the image as the processing target using the setting at the time when capturing the image.

The reference numeral 301 in FIG. 3 denotes an encoded image to be edited, to which an imaging condition is added. The image to be edited is decompressed by an decompression processing unit 302, and the RGB data is converted into BAYER data arranged in a grid. The BAYER data is subjected to interpolation processing by an interpolation processing unit 303 and converted into RGB data. The interpolated RGB data is saved in a post-interpolation cache 304. Data in the post-interpolation cache 304 can be reused until the editing process is terminated. Therefore, when the second and subsequent editing instructions are issued, the data in the post-interpolation cache 304 can be used without the decompression processing and the interpolation processing.

The reference numeral 305 denotes an exposure correction processing unit that changes a value of RGB data, which is a value affecting the exposure correction processing, in accordance with an input exposure correction editing instruction 306. The reference numeral 307 denotes a white balance processing unit that changes RGB data, which is a value affecting white balance processing, in accordance with an input white balance editing instruction 308. A conversion processing unit 309 converts the RGB value into an YCrCb value, passes a Y value to a contrast processing unit 312, and passes Cr and Cb to a color tone processing unit 314. The values before applying the luminance system process and the color system process are respectively stored as intermediate results in a pre-luminance process cache 310 and a pre-color process cache 311.

The intermediate results saved in the pre-luminance process cache 310 and the pre-color process cache 311 can be reused as long as the exposure correction and the white balance adjustment values are not changed. Therefore, when the editing instruction related to an editing item other than the exposure correction and the white balance is received, the data in the pre-luminance process cache 310 and the pre-color process cache 311 can be used without the processing therebefore.

The contrast processing unit 312 changes the Y value in accordance with an input contrast editing instruction 313. The color tone processing unit 314 changes the Cr value and the Cb value in accordance with an input color editing instruction 315. The reference numeral 316 denotes a color density processing unit that changes the Cr value and the Cb value in accordance with an input color density editing instruction 317. The reference numeral 318 denotes a sharpness processing unit that changes the Y value in accordance with an input sharpness editing instruction 319. The Y and CrCb data generated by the color density processing unit 316 and the sharpness processing unit 318 are respectively saved in a post-luminance process cache 320 and a post-color processing cache 321 as intermediate results.

The data in the post-luminance process cache 320 can be reused as long as the adjustment values for exposure correction, white balance, contrast, or sharpness are not changed. The data in the post-color processing cache 321 can be reused as long as the adjustment values for exposure correction, white balance, color tone, or color density are not changed.

A conversion processing unit 322 converts the YCrCb value into an RGB value. The RGB value obtained as a result is saved in a post-color/luminance process cache 323 as intermediate results for reuse. The reference numeral 324 denotes a tone curve processing unit that edits the RGB data in accordance with a tone curve editing instruction 325 issued in instruction by the user. Then, the edited RGB data becomes an output 326.

The development process of the RAW image is performed in the above described procedure. The intermediate results stored in caches 304, 310, 311, 320, 321, and 323 are not newly generated as long as being available to be reused and, only when the result cannot be reused, the current intermediate results are discarded and the intermediate results are newly generated and recorded. As a result, even when the user issues instruction for editing, the editing result can be generated at high speed by omitting a part of the development processing depending on the editing item.

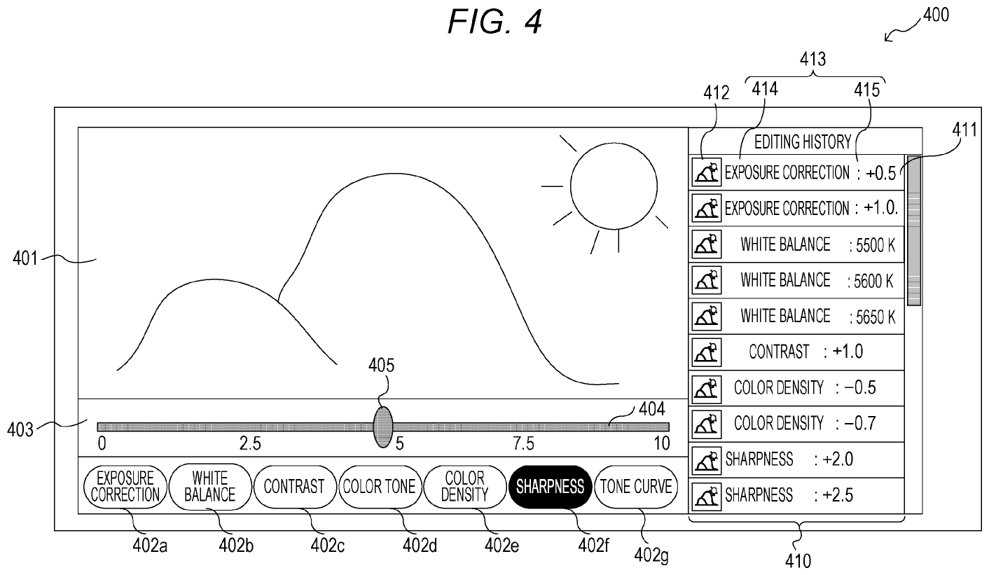

FIG. 4 is a diagram illustrating an example of the image editing screen 400 displayed on the display unit 105. On the image region 401, an image developed by the development processing unit 202 is displayed, and when the image is edited, an image after editing is displayed. Further, on the image editing screen 400, an exposure correction editing button 402a, a white balance editing button 402b, a contrast editing button 402c, and a color tone editing button 402d are displayed. On the image editing screen 400, a color density editing button 402e, a sharpness editing button 402f, and a tone curve editing button 402g are also displayed.

When one of the editing buttons 402a to 402g is pressed on the image editing screen 400, an editing operation area corresponding to the pressed editing button is displayed. The example illustrated in FIG. 4 represents a case where the sharpness editing button 402f is pressed. In this case, on the image editing screen 400, an editing operation area 403 for adjusting sharpness is displayed and, on the editing operation area 403, a slider bar 404 for inputting an adjustment value of sharpness is displayed. An adjustment range of the slider bar 404 is from 0 to 10. When a position of a slider 405 is changed on the slider bar 404, the development processing unit 202 performs image editing relating to sharpness according to the adjustment value corresponding to the changed position of the slider 405. Then, the display processing unit 205 displays the image after editing in the image region 401. The editing operation area 403 may be any UI capable of inputting the adjustment value in a display mode corresponding to the editing item, and may be a UI in which the adjustment value is input using a drop down box or a check box instead of the slider bar. The editing operation area 403 according to the present exemplary embodiment is an example of an entry field for adjustment values in editing items.

Furthermore, in an editing history area 410, a plurality of pieces of history information 411 indicating edit content performed earlier are displayed in chronological order. Each history information 411 includes a thumbnail image 412 of the edited image and an edit content 413. Further, the edit content 413 includes an editing item 414 and an adjustment value 415. In other words, in the editing history area 410, editing items and adjustment values are displayed in association with each other as content of the display. The adjustment value is a value corresponding to the stopped position of the slider 405 operated in the editing operation area 403 regarding the editing item. Furthermore, every time editing is performed by the development processing unit 202, history information 411 corresponding to the newly performed editing is added to the editing history area 410. In addition, a series of history information is stored in the external storage medium 106 as being linked to the RAW image being edited as one group. Then, every time a new editing is performed on the RAW image, history information corresponding to the newly performed edit content is added to the group of the series of history information and stored. In addition, a plurality of groups can be linked to the single RAW image and stored.

During a series of editing on the single RAW image, editing corresponding to the same editing item may be performed more than one time. In this case, the edit content being applied to the RAW image as a processing target is only the edit content using a new adjustment value. Therefore, in the editing history, for one editing item, there are edit content being applied to the RAW image as a processing target and edit content not being applied. Thus, the image processing apparatus 100 according to the present exemplary embodiment distinguishes and displays the edit contents to be distinguishable by the user. More specifically, the image processing apparatus 100 normally displays the edit content 413 which is being applied, and invalidly displays the edit content 413 which is not being applied. According to the present exemplary embodiment, the normal display is to highlight with a black frame, and the invalid display is to perform display in a lighter color (gray). Note that the normal display and the invalid display may be display modes that allow the user to distinguish that the displays are different from each other, and are not limited to the exemplary embodiment. As another example, the thickness of the line indicating the edit content in the normal display may be made thicker than the thickness of the frame indicating the edit content in the invalid display. Further, as another example, the normal display and the invalid display may be displayed in different display colors.

When there are many edit contents, a part of the edit contents is displayed in the editing history area 410, and the displayed edit contents are switched by scrolling in response to the user's operation. In FIG. 4, the exposure correction “+1.0”, the white balance “5650K”, and the color density “−0.7” are normally displayed to indicate that they are being applied. Also, the exposure correction “+0.5”, white balance “5500K” and “5600K”, the color density “−0.5” are invalidly displayed to indicate that they had been applied earlier but are not currently applied. And, in FIG. 4, the edit contents of contrast and sharpness being displayed in the editing history area 410 are invalidly displayed and indicate that they are not being applied. The user operates the history information 411 to change the edit content displayed in the editing history area 410, so that the edit content being applied can be displayed and verified in terms of contrast and sharpness.

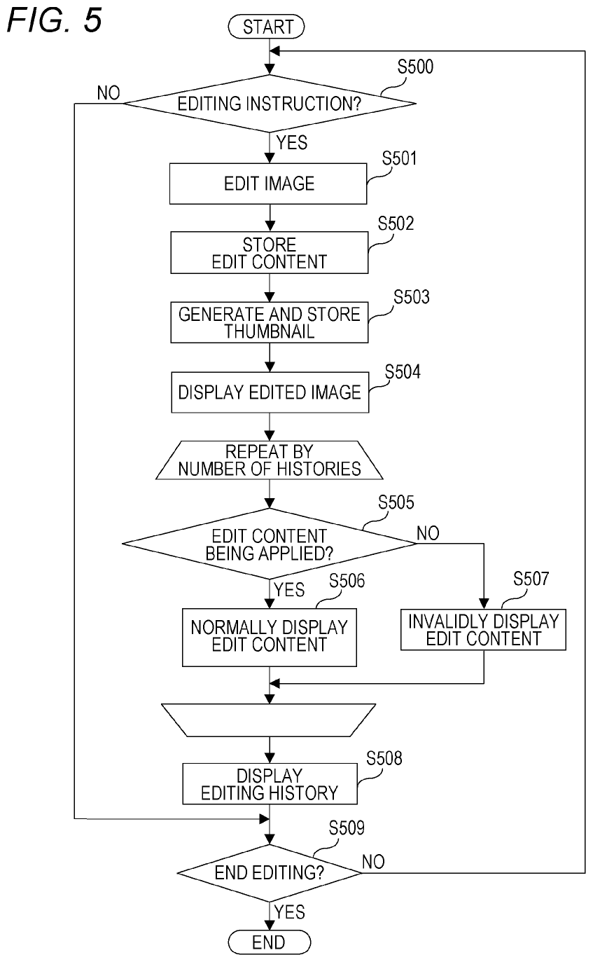

FIG. 5 is a flowchart illustrating an image editing process by the image processing apparatus 100. The processes executed by the following units are realized by the control unit 101 operating according to an operating system (OS) or an image editing application program. When the control unit 101 starts up an image editing application, the control unit 101 causes the display unit 105 to display the image editing screen 400. The image editing screen 400 at start-up time displays an image editing result that a development process has been performed on a RAW image as an editing target with predetermined adjustment values. First, in S500, the receiving unit 201 determines whether an editing instruction is received. When one of the editing buttons 402a to 402g on the image editing screen 400 is selected by the user, the receiving unit 201 receives an editing instruction corresponding to the selected one of the editing buttons 402a to 402g. When the receiving unit 201 receives the editing instruction (YES in S500), the receiving unit 201 proceeds the process to S501. When the receiving unit 201 does not receive the editing instruction (NO in S500), the process proceeds to S509. In S501, the development processing unit 202 edits the image as the processing target according to the editing instruction. As described above, the development processing unit 202 can use the intermediate result stored in the buffer in the editing process according to need. Then, in S502, the history management unit 203 associates (links) the history information corresponding to the edit content related to the editing process with the edited image and stores the data in the external storage medium 106. Here, the edit content includes the editing item related to the editing process and the setting value (adjustment value) corresponding to the editing item. The image associated with the history information may be an image before editing.

Next, in S503, the development processing unit 202 generates a thumbnail image from the image after the editing process. Then, the history management unit 203 associates the thumbnail image (reduced image) with the edit content stored in S502, adds history information indicating the edit content to a group of a series of history information, and stores the information in the external storage medium 106. Here, the image generated in S503 may be an image having a smaller data size than the image after the editing process. Next, in S504, the display processing unit 205 performs control to display the image after the editing process in the image region 401 of the image editing screen 400.

The subsequent processes of S505 to S507 are processes for updating the display content of the editing history area 410, and are processes which are repeated by a number of edit contents stored in the history storage unit 204 and displayed in the editing history area 410. In S505, the history management unit 203 selects, as a processing target, one edit content stored in the history storage unit 204. Then, the history management unit 203 determines whether the edit content as the processing target is the edit content being applied to the image. When the edit content is being applied to the image (YES in S505), the history management unit 203 proceeds the process to S506. When the edit content is not being applied to the image (NO in S505), the history management unit 203 proceeds the process to S507. Note that, in S505, the history management unit 203 refers to a series of history information of the image as the processing target, and searches whether the history information of the editing item same as that of the edit content as a determination target exists later in time series than the edit content as the determination target. Then, as a result of the search, when there is a later edit content, it is determined that the edit content of the determination target is not being applied (No in S505) and, when there is no later edit content, it is determined that the edit content of the determination target is being applied (Yes in S505). Alternatively, in step S505, the history management unit 203 compares the editing item of the edit content as the determination target with the editing item of the editing instruction received in S501. Then, the history management unit 203 determines that the edit content is not being applied when the edit content is in the same editing item (No in S505), and determines that the edit content of the determination target is being applied when the edit content is in a different editing item (Yes in S505). This is because, in the same editing item, when the new edit content is applied, the edit content in the existing history information is not applied any more.

In S506, the history management unit 203 determines the display mode of the edit content of the processing target as the normal display. In S507, the history management unit 203 determines the display mode of the edit content of the processing target as the invalid display. When the repetition process terminates, subsequently, in S508, the display processing unit 205 associates the edit content and the thumbnail image with each other to be displayed in the editing history area 410 as editing history. At this time, the display processing unit 205 invalidly displays the edit content that the invalid display is determined, and normally displays the display content that the normal display is determined. This process is an example of the display processing. Next, in S509, the control unit 101 determines whether an instruction to terminate the image editing process is received. When the control unit 101 receives a termination instruction (YES in S509), the control unit 101 terminates the image editing process. When the control unit 101 does not receive the termination instruction (NO in S509), the control unit 101 proceeds the process to S500.

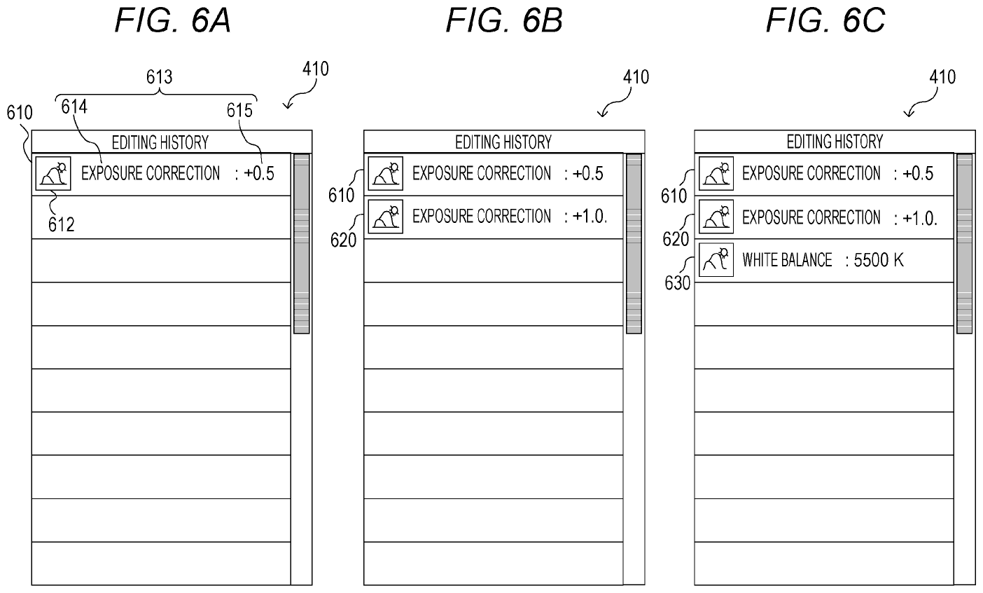

Next, the process of displaying the editing history will be described in detail with reference to FIGS. 6A to 6C. It is assumed that the exposure correction with an adjustment value “+0.5” is performed on the image as the processing target according to the user's operation. In this case, as illustrated in FIG. 6A, history information 610 including an edit content 613 including an editing item 614 “exposure correction” and an adjustment value 615 “+0.5” and a corresponding thumbnail image 612 is added to the editing history area 410. At this time, since the edit content 613 of the history information 610 is applied to the image, the edit content 613 of the history information 610 is normally displayed.

Thereafter, it is assumed that the exposure correction with an adjustment value “+1.0” is performed according to the user's operation. In this case, as illustrated in FIG. 6B, history information 620 including the edit content of the editing item “exposure correction” and the adjustment value “+1.0” and the thumbnail image is added to the editing history area 410. At this time, the edit content of the history information 620 is being applied to the image. Therefore, the edit content of the history information 620 is normally displayed. On the other hand, the edit content of the history information 610 is not being applied. Therefore, the edit content of the history information 610 is changed to be displayed invalidly.

Furthermore, it is assumed that the white balance editing process of the adjustment value “5500K” is subsequently performed according to the user's operation. In this case, as illustrated in FIG. 6C, history information 630 including the edit content of the editing item “white balance” and an adjustment value “5500K” and the thumbnail image is added to the editing history area 410. At this time, since the edit content of the history information 630 is being applied to the image, the edit content of the history information 630 is normally displayed. Since the history information 620 is also being applied, the normal display of the history information 630 is maintained.

As described above, the image processing apparatus 100 according to the present exemplary embodiment can display the edit content being applied to the image and the edit content not being applied to the image in a distinguishable manner, regarding each editing item. Therefore, the user can easily recognize the edit content being applied to the image and the edit content not being applied to the image.

As a modification of the first exemplary embodiment, the history information may be stored in an external device as a substitute for the image processing apparatus 100. In this case, the image processing apparatus 100 acquires history information via the communication unit 107.

### Second Exemplary Embodiment

Next, the image processing apparatus 100 according to the second exemplary embodiment will be described, mainly on a difference from the image processing apparatus 100 described in the first exemplary embodiment. The image processing apparatus 100 according to the present exemplary embodiment displays only an edit content being applied to the image as the editing history according to the user's operation.

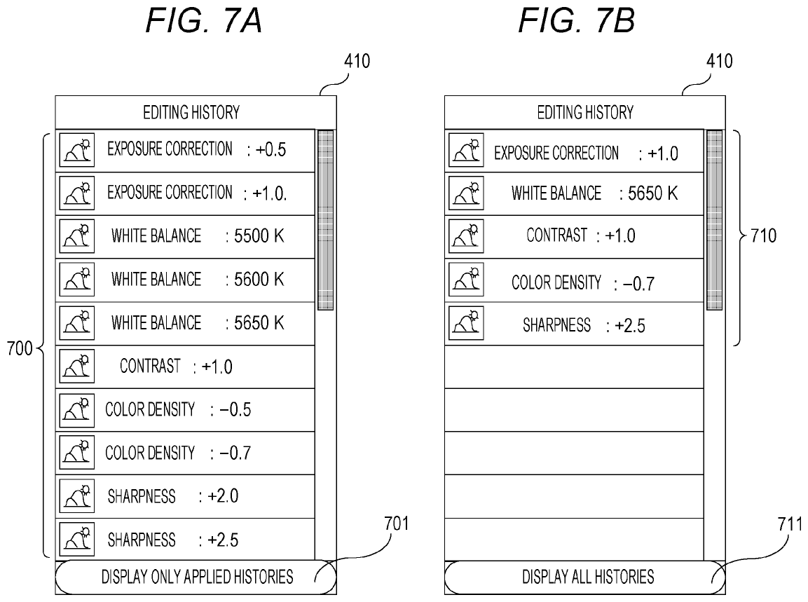

In the editing history area 410 illustrated in FIG. 7A, a history list 700 including history information corresponding to edit contents being applied and history information corresponding to edit contents not being applied is displayed. Furthermore, below the editing history area 410, a switching button 701 for displaying only the history being applied is displayed. In the editing history area 410 illustrated in FIG. 7B, a history list 710 including only history information corresponding to the edit contents being applied and not including history information corresponding to edit content not being applied is displayed. Furthermore, below the editing history area 410, a switching button 711 for displaying all the histories is displayed. When the switching button 701 illustrated in FIG. 7A is pressed, the display of the editing history area 410 is switched to the history list 710 that includes only history information corresponding to the edit contents being applied, as illustrated in FIG. 7B. In other words, the history information corresponding to the edit content not being applied is hidden. On the other hand, when the switching button 711 illustrated in FIG. 7B is pressed, the display of the editing history area 410 is switched to the history list 700 including all pieces of history information as illustrated in FIG. 7A.

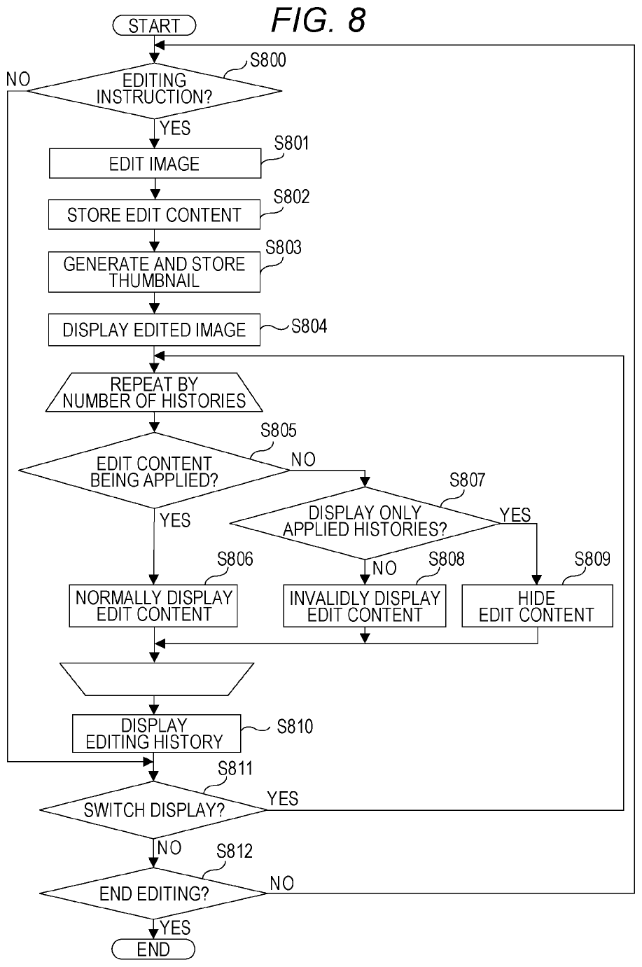

FIG. 8 is a flowchart illustrating an image editing process according to the second exemplary embodiment. The processes of S800 to S804 are the same as the processes of S500 to S504 described with reference to FIG. 5 in the first exemplary embodiment. After the process of S804, the control unit 101 performs the processes of S805 to S809. The processes of S805 to S809 are processes repeated by the number of edit contents stored in the history storage unit 204. In S805, the history management unit 203 selects one edit content stored in the history storage unit 204 as a processing target. Then, the history management unit 203 determines whether the edit content as the processing target is an edit content being applied to the image. When the edit content is being applied to the image (YES in S805), the history management unit 203 proceeds the process to S806. When the edit content is not being applied to the image (NO in S805), the history management unit 203 proceeds the process to S807. In S806, the history management unit 203 determines that the display mode of the edit content as the processing target to be the normal display.

In S807, the history management unit 203 verifies the display mode of the editing history area 410 at the time of processing. When the display mode is a display mode in which only the history information being applied to the image is displayed (YES in S807), the history management unit 203 proceeds the process to S809. When the display mode is the display mode in which all pieces of history information are displayed (NO in S807), the history management unit 203 proceeds the process to S808. In S808, the history management unit 203 determines to invalidly display the edit content as the processing target. In S809, the history management unit 203 determines to hide the edit content as the processing target.

When the repetition process is completed, subsequently, in S810, the display processing unit 205 associates the edit content and a thumbnail image with each other to be displayed as editing history in the editing history area 410. In the case of a display mode in which all pieces of history information are displayed, all edit contents are displayed. In this case, the edit content is displayed in a distinguishable manner whether the edit content is being applied by normal display and invalid display. On the other hand, in the case of a display mode in which only the history information being applied to the image is displayed, only the edit content being applied is displayed as history information.

Next, in S811, the history management unit 203 determines whether a switching instruction is received in response to pressing of the switching button 701 or 711. When the history management unit 203 receives a switching instruction (YES in S811), the history management unit 203 proceeds the process to the repetition processes of S805 to S809. Thus, processing is performed to display the edit content according to the display mode after switching by the switching buttons 701 and 711. When the history management unit 203 does not receive the switching instruction (NO in S811), the history management unit 203 proceeds the process to S812. In S812, the control unit 101 determines whether an instruction to terminate the image editing process is received. When the control unit 101 receives a termination instruction (YES in S812), the control unit 101 terminates the image editing process. When the control unit 101 does not receive the termination instruction (NO in S812), the control unit 101 proceeds the process to S801. Here, other configurations and processing of the image processing apparatus 100 according to the second exemplary embodiment are similar to the configurations and processing of the image processing apparatus 100 according to the first exemplary embodiment.

As described above, the image processing apparatus 100 according to the second exemplary embodiment can display only the edit content being applied to the image. This improves the visibility of the edit content being applied, and allows the user to easily find a desired history.

As a modification of the second exemplary embodiment, when the history information does not fit in the editing history area 410, the image processing apparatus 100 may display only the edit contents being applied without displaying the edit contents not being applied. As described above, the display timing of the edit content is not limited to the exemplary embodiment as long as the image processing apparatus 100 displays the edit content being applied.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Although the preferred exemplary embodiments have been described above in detail, the present disclosure is not limited to the specific exemplary embodiments, and various modifications may be made within the scope of the present disclosure as set forth in the claims. The scope of the following claims is to be accorded the broadest interpretation so as to encompass all such modifications and equivalent structures and functions.

According to the present disclosure, a system is provided by which the user can easily recognize an edit content being applied to an image and an edit content not being applied to the image for each editing item in editing history.

This application claims the benefit of Japanese Patent Application No. 2018-162745, filed Aug. 31, 2018, which is hereby incorporated by reference herein in its entirety.

What is claimed is:

1. An image processing apparatus comprising:
an editing unit configured to edit an image according to user's operation;
a storage unit configured to store, in a storage medium, an editing history indicating an edit content executed by the editing unit by associating the editing history with the image; and
a display processing unit configured to display each edit content on a screen in a different manner depending on being applied to the image or not being applied to the image.

2. The image processing apparatus according to claim 1, wherein the display processing unit performs control to highlight the edit content being applied.

3. The image processing apparatus according to claim 1, wherein the display processing unit performs control to display each edit content on the screen in a different color depending on being applied to the image or not being applied to the image.

4. The image processing apparatus according to claim 1, wherein the display processing unit performs control to display the edit content being applied to the image and hide the edit content not being applied to the image.

5. The image processing apparatus according to claim 1, wherein the display processing unit performs control to associate and display, as the edit content, an editing item and an adjustment value of the editing item.

6. The image processing apparatus according to claim 5, wherein, in the edit contents of a same editing item in the editing history stored in the storage medium, the display processing unit displays, on the screen, a chronologically later edit content in a display mode indicating a state being applied to the image and displays, on the screen, a chronologically former edit content in a display mode indicating a state not being applied to the image.

7. The image processing apparatus according to claim 5, wherein, when the editing unit newly performs editing to the image, the display processing unit displays, on the screen in a display mode indicating a state not being applied to the image, the edit content of the editing item same as that of the newly performed editing to the image in the plurality of edit contents in the editing history stored in the storage unit.

8. The image processing apparatus according to claim 1, wherein an order of the plurality of edit contents included in the editing history are displayed on the screen is different from an order that the plurality of the edit contents used by the editing unit to perform an edit process to the image.

9. The image processing apparatus according to claim 1, wherein the display processing unit displays, on the screen, a part of the plurality of edit contents included in the editing history and changes the part of the plurality of edit contents to be displayed on the screen according to user's operation.

10. The image processing apparatus according to claim 1, wherein the image is a RAW image.

11. An image processing method executed by an image processing apparatus, the method comprising:
editing an image according to user's operation;
storing, in a storage medium, an editing history indicating an edit content in the editing by associating the editing history with the image; and
displaying each edit content on a screen in a different manner depending on being applied to the image or not being applied to the image.

12. The method according to claim 11, further comprising:
performing control to highlight, in the display, the edit content being applied.

13. The method according to claim 11, further comprising:
displaying each edit content on the screen in a different color depending on being applied to the image or not being applied to the image.

14. The method according to claim 11, further comprising:
displaying the edit content being applied to the image and hiding the edit content not being applied to the image.

15. The method according to claim 11, further comprising:
associating and displaying, as the edit content, an editing item and an adjustment value of the editing item.

16. The method according to claim 15, wherein, in the edit contents of a same editing item in the editing history stored in the storage medium, and further comprising:
displaying, on the screen, a chronologically later edit content in a display mode indicating a state being applied to the image and displaying, on the screen, a chronologically former edit content in a display mode indicating a state not being applied to the image.

17. The method according to claim 15, wherein, when newly performing editing to the image, further comprising
displaying, on the screen in a display mode indicating a state not being applied to the image, the edit content of the editing item same as that of the newly performed editing to the image in the plurality of edit contents in the editing history stored in the storage.

18. The method according to claim 11, wherein an order of the plurality of edit contents included in the editing history are displayed on the screen is different from an order that the plurality of the edit contents used by the editing unit to perform an edit process to the image.

19. The image processing apparatus according to claim 11, further comprising:
displaying, on the screen, a part of the plurality of edit contents included in the editing history and changes the part of the plurality of edit contents to be displayed on the screen according to user's operation.

20. A non-transitory computer readable storage medium that stores instructions that, when executed, cause an image processing apparatus to execute:
editing an image according to user's operation;
storing, in a storage medium, an editing history indicating an edit content in the editing by associating the editing history with the image; and
displaying each edit content on a screen in a different manner depending on being applied to the image or not being applied to the image.
